(19) United States
(12) Patent Application Publication
(10) Pub. No.: US 2025/0383958 A1
(43) Pub. Date: Dec. 18, 2025

(54) MEMORY SYSTEM, MEMORY CONTROLLER, AND METHOD OF CONTROLLING NONVOLATILE MEMORY

(71) Applicant: Kioxia Corporation, Tokyo (JP)

(72) Inventors: Yuta KUMANO, Kawasaki (JP); Hironori UCHIKAWA, Fujisawa (JP)

(73) Assignee: Kioxia Corporation, Tokyo (JP)

(21) Appl. No.: 18/974,157

(22) Filed: Dec. 9, 2024

(30) Foreign Application Priority Data
Jun. 18, 2024 (JP) 2024-097809

(51) Int. Cl. G06F 11/10

(52) U.S. Cl. CPC G06F 11/1048; G06F 11/1004; G06F 11/1016

(57) ABSTRACT

According to one embodiment, a memory system includes a nonvolatile memory storing an error correction code, and a memory controller. The memory controller reads out readout information from the nonvolatile memory by using a first readout voltage, executes decoding processing by using first input information that is one of the readout information and likelihood information obtained by converting the readout information by first conversion information, when the decoding processing has failed, further executes the decoding processing by using second input information obtained by correcting the first input information to be a value obtainable when being read out by a second readout voltage different from the first readout voltage, and estimates a third readout voltage based on reliability degree information indicating a reliability degree of the decoding processing.

### CROSS-REFERENCE TO RELATED APPLICATIONS

This application is based upon and claims the benefit of priority from Japanese Patent Application No. 2024-097809, filed on Jun. 18, 2024; the entire contents of which are incorporated herein by reference.

### FIELD

Embodiments described herein relate generally to a memory system, a memory controller, and a control method.

### BACKGROUND

In a memory system, error correction encoded data is generally stored in order to protect the stored data. For this reason, when the data stored in the memory system is read out, decoding for the error correction encoded data is performed.

### BRIEF DESCRIPTION OF THE DRAWINGS

FIG. 1 is a block diagram of a memory system according to a first embodiment;

FIG. 2 is a block diagram illustrating a schematic configuration example of a decoder;

FIG. 3 is a diagram illustrating an example of a sign shift function;

FIG. 4 is a diagram illustrating an example of a sign shift function;

FIG. 5 is a diagram illustrating an example of estimation processing of an optimum readout voltage;

FIG. 6 is a flowchart of decoding processing to be executed by the memory system according to the first embodiment;

FIG. 7 is a diagram illustrating the overview of decoding processing of Modified Example 1;

FIG. 8 is a diagram illustrating an example of iterative processing of a sign shift function in Modified Example 1;

FIG. 9 is a diagram illustrating an example of iterative processing of a sign shift function in Modified Example 2;

FIG. 10 is a diagram illustrating Comparative Example in which decoding fails;

FIG. 11 is a diagram illustrating a processing example according to a second embodiment; and

FIG. 12 is a flowchart of decoding processing to be executed by a memory system according to the second embodiment.

### DETAILED DESCRIPTION

In general, according to one embodiment, a memory system includes a nonvolatile memory storing an error correction code, and a memory controller. The memory controller is configured to: read out readout information from the nonvolatile memory by using a first readout voltage; execute decoding processing by using first input information, the first input information being one of the readout information and likelihood information obtained by converting the readout information by first conversion information; when the decoding processing fails, further execute the decoding processing by using second input information obtained by correcting the first input information to be a value obtainable when being read out by a second readout voltage different from the first readout voltage; and estimate a third readout voltage based on reliability degree information indicating a reliability degree of the decoding processing.

Exemplary embodiments of a memory system will be explained below in detail with reference to the accompanying drawings. The present invention is not limited to the following embodiments.

### First Embodiment

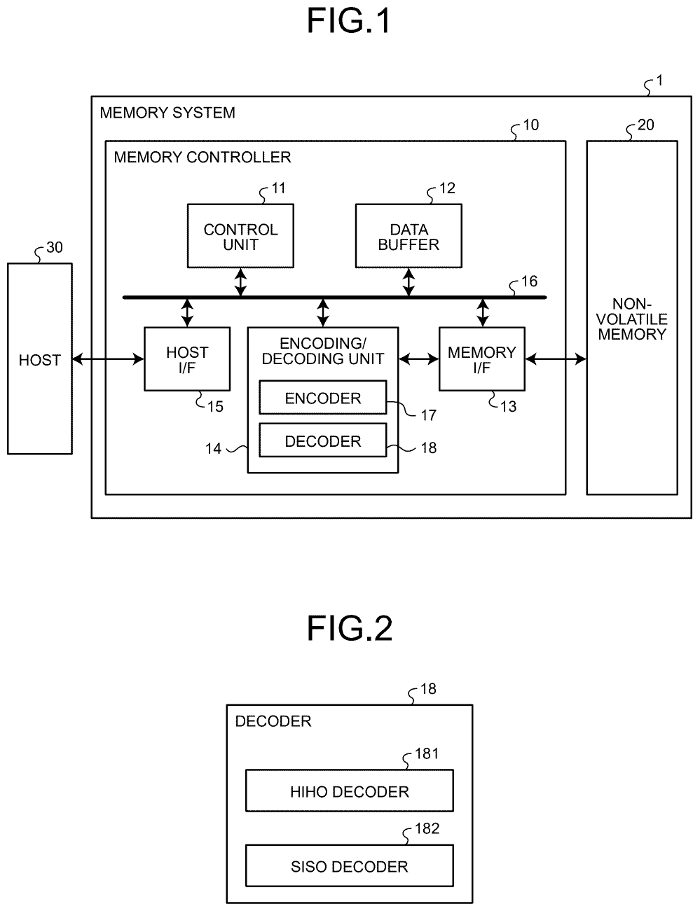

FIG. 1 is a block diagram of a memory system according to the first embodiment. As illustrated in FIG. 1, a memory system 1 includes a memory controller 10 and a nonvolatile memory 20. The memory system 1 can connect with a host 30, and FIG. 1 illustrates a state in which the memory system 1 is connected with the host 30. The host 30 may be an electronic device such as a personal computer or a mobile terminal, for example.

The nonvolatile memory 20 is a nonvolatile memory that stores data in a nonvolatile manner, and is a not-AND (NAND) memory, for example. In the following description, a case where a NAND memory is used as the nonvolatile memory 20 is exemplified, but a storage device other than the NAND memory such as a three-dimensional structure flash memory, a resistance random access memory (ReRAM), or a ferroelectric random access memory (FeRAM) can be used as the nonvolatile memory 20. Further, the nonvolatile memory 20 needs not be always a semiconductor memory, and the present embodiment can also be applied to various storage media other than the semiconductor memory.

The memory system 1 may be a memory card or the like in which the memory controller 10 and the nonvolatile memory 20 are formed as one package, or may be a solid state drive (SSD) or the like.

In accordance with a writing request from the host 30, the memory controller 10 controls writing into the nonvolatile memory 20. Further, in accordance with a readout request from the host 30, the memory controller 10 controls readout from the nonvolatile memory 20. The memory controller 10 includes a host interface (host I/F) 15, a memory interface (memory I/F) 13, a control unit 11, an encoding/decoding unit (codec) 14, and a data buffer 12. The host I/F 15, the memory I/F 13, the control unit 11, the encoding/decoding unit 14, and the data buffer 12 are connected to each other via an internal bus 16.

The host I/F 15 is a circuit that executes processing in compliance with an interface standard with the host 30, and outputs a command received from the host 30, and user data to be written, to the internal bus 16. Further, the host I/F 15 transmits user data read out from the nonvolatile memory 20 and restored, and a response from the control unit 11 to the host 30.

The memory I/F 13 is a circuit that performs writing processing into the nonvolatile memory 20 based on an instruction of the control unit 11. The memory I/F 13 also performs readout processing from the nonvolatile memory 20 based on an instruction of the control unit 11.

The control unit 11 comprehensively controls each component of the memory system 1. The control unit 11 may be implemented by a process such as a central processing unit (CPU), for example, executing firmware, or may be implemented by a hardware circuit. In a case where the control unit 11 receives a command from the host 30 via the host I/F 15, the control unit 11 performs control in accordance with the command. For example, in accordance with the command from the host 30, the control unit 11 issues an instruction to write user data and parity into the nonvolatile memory 20, to the memory I/F 13. Further, in accordance with the command from the host 30, the control unit 11 issues an instruction to read out user data and parity from the nonvolatile memory 20, to the memory I/F 13.

Further, in a case where the control unit 11 has received a user data writing request from the host 30, the control unit 11 accumulates the user data into the data buffer 12, and decides a storage region (memory region) of the user data in the nonvolatile memory 20. In other words, the control unit 11 manages a writing destination of user data. Correspondence between a logical address of user data received from the host 30, and a physical address indicating a storage region on the nonvolatile memory 20 in which the user data is stored is stored as an address conversion table.

Further, in a case where the control unit 11 has received a readout request from the host 30, the control unit 11 converts a logical address designated by the readout request, into a physical address using the aforementioned address conversion table, and issues a readout instruction from the physical address to the memory I/F 13.

In the NAND memory, generally, writing and readout are performed in a data unit called a page, and erasing is performed in a data unit called a block. In the present embodiment, a plurality of memory cells connected to an identical word like is called a memory cell group. In a case where a memory cell is a single level cell (SLC), one memory cell group corresponds to one page. In a case where a memory cell is a multi-level cell (MLC), one memory cell group corresponds to a plurality of pages. Further, each memory cell is connected to a word line, and connected also to a bit line. Accordingly, each memory cell can be identified based on an address for identifying a word line, and an address for identifying a bit line.

Further, in response to a readout instruction issued by the memory controller 10, by applying a readout voltage to a word line, the NAND memory reads out data from a plurality of memory cells, and transmits the read data to the memory controller 10.

The memory cell is a field-effect transistor, for example. The memory cell includes a semiconductor layer, a gate insulator film, and a gate electrode. The gate insulator film includes a charge accumulation layer (insulating film or conducting film). A charge amount in a charge accumulation layer corresponds to any of a plurality of distributions (threshold value distributions). A voltage to be applied to a word line in a case where data is to be read out from a plurality of memory cells varies depending on the charge amount in the charge accumulation layer.

For the ease of explanation, an example of one-bit/cell in which one memory cell stores one-bit data will be described. In the case of one-bit/cell, either one of two threshold value distributions corresponds to “0”, and the other one corresponds to “1”. In a case where a voltage is applied to a word line, Across a boundary being a voltage value corresponding to a charge amount of the memory cell, current flows in some cases and current does not flow in other cases when the voltage is applied. The voltage serving as a boundary voltage is decided in accordance with the charge amount of the memory cell. The voltage to be decided in accordance with the charge amount of the memory cell will be referred to as a threshold value voltage or a reference readout voltage. By applying the reference readout voltage to the word line, the NAND memory can determine whether or not data stored in this memory cell is 1.

Hereinafter, reading out data from the memory cell as a hard decision value of 1 or 0 will be referred to as hard bit read. In the hard bit read executed by the memory controller 10, a reference readout voltage is applied as a readout voltage to a word line connected to a memory cell, whether data stored in the memory cell is 1 or 0 is determined, and a determination result is output to the memory controller 10 as read data. Further, in the hard bit read, the readout voltage is sometimes changed from the reference readout voltage. In this case, a difference between the readout voltage and the reference readout voltage is designated based on a readout instruction from the memory controller 10.

The data buffer 12 temporarily stores user data received by the memory controller 10 from the host 30, until the user data is stored into the nonvolatile memory 20. Further, the data buffer 12 temporarily stores user data read out from the nonvolatile memory 20, until the user data is transmitted to the host 30. As the data buffer 12, for example, a general-purpose memory such as a static random access memory (SRAM) or a dynamic random access memory (DRAM) can be used.

User data to be transmitted from the host 30 is transferred to the internal bus 16 and once stored into the data buffer 12. The encoding/decoding unit 14 generates a code word by encoding the user data. Further, the encoding/decoding unit 14 restores the user data by decoding a received word read out from the nonvolatile memory 20. Thus, the encoding/decoding unit 14 includes an encoder 17 and a decoder 18. The encoding/decoding unit 14 may be implemented by a process such as a CPU, for example, executing firmware, or may be implemented by a hardware circuit. In addition, data to be encoded by the encoding/decoding unit 14 may include control data or the like to be used inside the memory controller 10, aside from the user data.

Next, writing processing of the present embodiment will be described. The control unit 11 issues an instruction to encode user data, to the encoder 17 when user data is to be written into the nonvolatile memory 20. At the time, the control unit 11 decides a storage location (storage address) of a code word in the nonvolatile memory 20, and also issues an instruction indicating the decided storage location, to the memory I/F 13.

Based on the instruction from the control unit 11, the encoder 17 encodes the user data on the data buffer 12 and generates a code word. As an encoding method, for example, BCH (Bose-Chaudhuri-Hocquenghem) encoding, Reed-Solomon (RS) encoding, or an encoding method that uses a concatenated code with the BCH and the RS code at least one of which is a component code can be adopted. The concatenated code is a code created by combining a plurality of codes, and includes an iterated code, for example.

An error correction code includes at least one or more symbols as a constituent unit. Further, one symbol includes, for example, one-bit (binary field) element), or an alphabet element such as a finite field other than the binary field. In addition, for the ease of explanation, hereinafter, description will be given using an example of a binary field error correction code in which one symbol includes one bit. In the description, symbol and bit might mixedly appear, both of which represent the same meaning.

In the first embodiment, an example of using one type of error correction code (BCH code, RS code, etc.) will be described. The memory I/F 13 performs control of storing a code word into a storage location on the nonvolatile memory 20 that is designated by the control unit 11.

Next, processing according to the present embodiment that is to be executed at the time of readout from the nonvolatile memory 20 will be described. At the time of readout from the nonvolatile memory 20, the control unit 11 designates an address on the nonvolatile memory 20 and issues a readout instruction to the memory I/F 13. The control unit 11 also issues a decoding start instruction to the decoder 18. In accordance with the instruction of the control unit 11, the memory I/F 13 reads out a received word from the designated address on the nonvolatile memory 20, and inputs the read received word to the decoder 18. The decoder 18 decodes the received word read out from the nonvolatile memory 20.

The decoder 18 decodes the received word read out from the nonvolatile memory 20. FIG. 2 is a block diagram illustrating a schematic configuration example of the decoder 18. The decoder 18 includes a hard-input hard-output (HIHO) decoder 181 that executes decoding using a hard decision value as an input, and outputs a hard decision value as a result thereof, and a soft-input soft-output (SISO) decoder 182 that executes decoding using a soft decision value (soft decision input value) as an input, and outputs a soft decision value (soft decision output value) as a result thereof.

Generally, SISO decoding is characterized by a higher error correction capability than HIHO decoding, but longer processing time. Thus, in the present embodiment, first of all, the HIHO decoder 181 is configured to HIHO-decode a received word read out from the nonvolatile memory 20 as a hard decision value, and read out a received word that has failed to be decoded by the hard decision decoding, as a soft decision value. Then, the SISO decoder 182 is configured to SISO-decode the received word read out as a soft decision value. Nevertheless, the configuration is not limited to such a configuration, and various modifications can be made by executing SISO decoding on all received words while omitting HIHO decoding, for example.

The SISO decoder 182 may include a memory (readout information memory) storing readout information (received word) read out from the nonvolatile memory 20 by soft decision. Among pieces of readout information, data corresponding to a hard decision value, which is binary information for defining whichever of 0 and 1 is indicated by each bit will be sometimes referred to as hard bit data. Further, data corresponding to a part of the readout information that excludes the hard bit data will be sometimes referred to as soft bit data. A readout information memory may include a hard bit memory (HMEM) storing the hard bit data, and a soft bit memory (CMEM) storing the soft bit data.

In the decoding processing, data called a channel value is sometimes required. A channel value indicates a value of a log-likelihood ratio (LLR) corresponding to a set of hard bit data and soft bit data. The channel value is sometimes called channel LLR data. The channel value is decided by an LLR table that associates a set of hard bit data and soft bit data, and a channel value, for example. The channel value is an example of a soft decision input value that is based on readout information of soft decision that is read out from the nonvolatile memory 20.

For example, in readout (soft bit read) executed by soft decision, one piece of hard bit data and a plurality of pieces of soft bit data are obtained. The one piece of hard bit data is obtained using the same readout voltage (hereinafter, will be referred to as “VrH”) as a readout voltage used in readout (hard bit read) executed by hard decision. Further, the plurality of pieces of soft bit data is obtained using a plurality of readout voltages including a readout voltage smaller in value than VrH, and a readout voltage larger in value than VrH. The LLR table is a table that associates channel values for each set of one piece of hard bit data and a plurality of pieces of soft bit data, for example. The SISO decoder 182 can decide a corresponding channel value using such an LLR table based on one piece hard bit data and a plurality of pieces of soft bit data that are included in readout information.

In the present embodiment in which a symbol is a binary field element, The LLR indicates probability information indicating whether a certain bit is 0 or 1. Hereinafter, the LLR is assumed to become positive when the probability that the bit is 0 is high, and become negative when the probability that the bit is 1 is high. Further, in the present embodiment, both of a soft decision input value and a soft decision output value are represented by the LLR.

The LLR can be represented by a contraction to binary information of 0 or 1 depending on the positivity or negativity of the value. Hereinafter, such binary information is sometimes called a hard decision value of an LLR. Further, hereinafter, in a case where the LLR is positive, a hard decision value is set to 0, in a case where the LLR is negative, a hard decision value is set to 1, and in a case where the LLR is 0, a hard decision value is decided in accordance with a predefined rule (e.g. a hard decision value is set to 0).

“A hard decision value of a channel value” corresponds to information indicating a channel value represented by the LLR, as a binary value depending on the positivity or negativity of the value as described above. In a similar manner, “a hard decision value of a soft decision input value” corresponds to information indicating a soft decision input value represented by the LLR, as a binary value depending on the positivity or negativity of the value as described above.

As described above, when data is read out from a memory cell, a readout voltage is applied to a word line connected to the memory cell. In a situation in which a readout voltage of an appropriate value is not set, that is to say, in a situation in which a readout voltage deviates from an appropriate value, in some cases, data fails to be correctly read out and decoding fails. In view of the foregoing, various countermeasures for situations in which a readout voltage deviates are proposed.

As one of the countermeasures, there is a function of, in a case where decoding processing that uses read data (readout information) fails, correcting readout information to be a value obtainable when being read out by a new readout voltage, instead of reading out data using a new readout voltage, and re-executing decoding processing using the corrected readout information. Hereinafter, such a function will be referred to as a sign shift function.

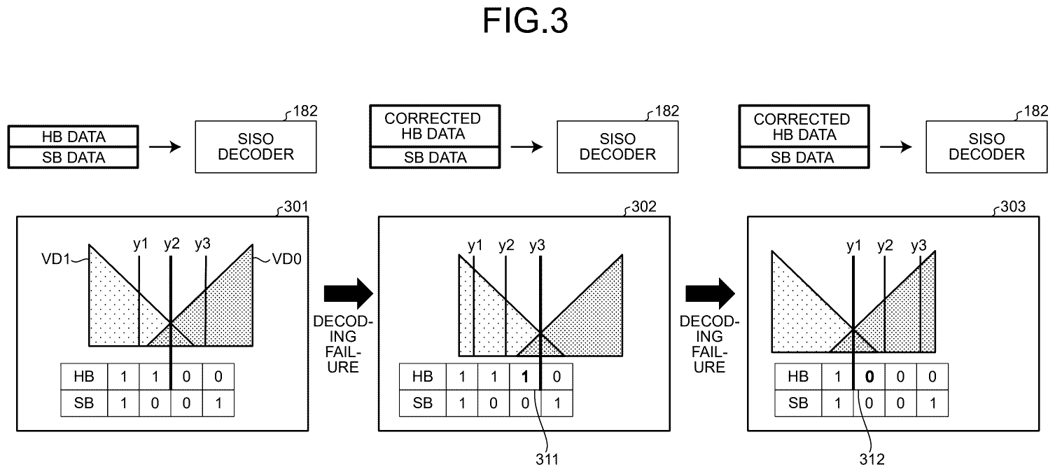

FIG. 3 is a diagram illustrating an example of the sign shift function. Hereinafter, hard bit data and soft bit data will be sometimes described as HB data and SB data, respectively. In addition, FIG. 3 illustrates an example in which one HB data and one SB data are obtained by soft bit read.

A threshold value distribution VD0 indicates a threshold value distribution corresponding to “0”, and a threshold value distribution VD1 indicates a threshold value distribution corresponding to “1”. Readout voltages y1, y2, and y3 indicate readout voltages with values set in such a manner as to increase in this order. The readout voltage y2 corresponds to the readout voltage VrH to be used in hard bit read, for example.

Processing 301 indicates first decoding processing on readout information including HB data and SB data. In the processing 301, the SISO decoder 182 executes decoding processing using HB data and SB data included in the readout information, as-is. In other words, in the processing 301, the readout information regarded as a value read out using the readout voltage y2 is used as-is in decoding processing.

In a case where the decoding processing of the processing 301 fails, processing 302 is executed. The processing 302 indicates processing of correcting readout information to be a value read out by the readout voltage y3, and re-executing decoding processing using the corrected readout information. In the example illustrated in FIG. 3, the SISO decoder 182 executes decoding processing using readout information including corrected HB data obtained by correcting HB data. The corrected HB data corresponds to data in which a value of HB data of bit with a set of (HB data, SB data) being (0, 0), among bits of HB data, is corrected to 1. In the processing 302, an example in which a value of HB data of bit 311 is corrected to 1 is illustrated.

In a case where the decoding processing of the processing 302 fails, processing 303 is executed. The processing 303 indicates processing of correcting readout information to be a value read out by the readout voltage y1, and re-executing decoding processing using the corrected readout information. In the processing 303, the corrected HB data corresponds to data in which a value of HB data of bit with a set of (HB data, SB data) being (1, 0), among bits of HB data, is corrected to 0. In the processing 303, an example in which a value of HB data of bit 312 is corrected to 0 is illustrated.

In this manner, HB data is corrected in such a manner that a value switches to 1 or 0 at a boundary corresponding to a switched readout voltage. In addition, SB data can be interpreted as data indicating a reliability degree (likelihood) of corresponding HB data. In the example illustrated in FIG. 3, a value of SB data indicates a lower reliability degree in the order of 0 and 1. The correction of HB data corresponds to processing of obtaining corrected HB data by inverting a value of HB data corresponding to SB data indicating a low reliability degree.

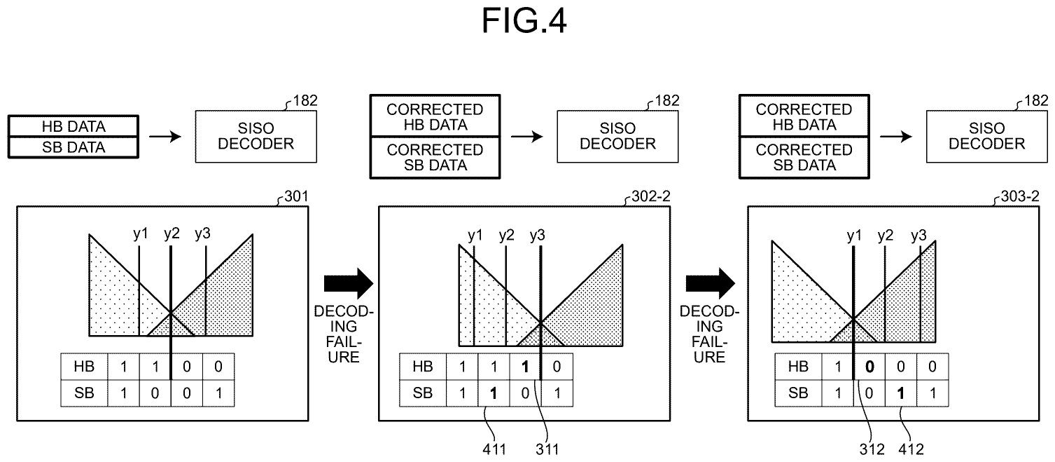

FIG. 3 illustrates an example in which a value of HB data in the set of (HB data, SB data) is corrected. A configuration in which a value of SB data is corrected in addition to HB data may be employed. FIG. 4 is a diagram illustrating an example of a sign shift function in a case where such a configuration is employed.

In the example illustrated in FIG. 4, processing 302-2 and processing 303-2 are changed from processing 302 and processing 303 illustrated in FIG. 3. Further, in the example illustrated in FIG. 4, the SISO decoder 182 executes decoding processing using readout information including corrected HB data obtained by correcting HB data, and corrected SB data obtained by correcting SB data. A generation method of the corrected HB data is similar to that in FIG. 3.

In the processing 302-2, the corrected SB data corresponds to data in which a value of SB data of bit with a set of (HB data, SB data) being (1, 0), among bits of SB data, is corrected to 1. In the processing 302-2, an example in which a value of SB data of bit 411 is corrected to 1 is illustrated.

In the processing 302-3, the corrected SB data corresponds to data in which a value of SB data of bit with a set of (HB data, SB data) being (0, 0), among bits of SB data, is corrected to 1. In the processing 302-3, an example in which a value of SB data of bit 412 is corrected to 1 is illustrated.

The correction of SB data using the SISO decoder 182 corresponds to processing of correcting data of bit including HB data with the same value as HB data with an inverted value, and SB data indicating a low reliability degree, to SB data indicating a high reliability degree. For example, in the processing 302-2, data of bit corresponding to a set (1, 0) of HB data with the same value of 1 as HB data of the bit 311 with the value inverted to 1, and SB data indicating a value of 0 (low reliability degree) is corrected to (1, 1). In the processing 302-3, data of bit corresponding to a set (0, 0) of HB data with the same value of 0 as HB data of the bit 312 with the value inverted to 0, and SB data indicating a value of 0 (low reliability degree) is corrected to (0, 1).

In this manner, in the sign shift function, a readout voltage regarded as being used in the readout of readout information is switched (shifted), decoding processing on readout information is iteratively executed. In addition, in the first decoding processing, the correction of readout information is not executed, but in the following description, the sign shift function is assumed to include the first decoding processing. In the examples illustrated in FIGS. 3 and 4, decoding processing iterated three times at most corresponds to the sign shift function. The number of times decoding processing is iterated is not limited to three.

In a situation in which a deviation of a readout voltage is large, and the number of error bits exceeds a range correctable by the decoder 18, even if the sign shift function is used, decoding processing sometimes fails. On the other hand, even if decoding processing that uses the sign shift function fails, in a situation in which the number of error bits is relatively small, error bit correction (correction processing) is expected to progress. Accordingly, for example, it becomes possible to evaluate a reliability degree (progress degree) of decoding processing based on the number of corrected bits indicating the number of bits corrected in decoding processing, and estimate a readout voltage used in decoding processing with a high reliability degree, to be a more appropriate readout voltage.

The present embodiment estimates an optimum readout voltage based on reliability degree information indicating a reliability degree of decoding processing to be executed using the sign shift function. The reliability degree information (reliability degree) is the number of corrected bits, for example.

The decoder 18 (the SISO decoder 182) first executes decoding processing using input information ID1 (first input information) being readout information read out from the nonvolatile memory 20 using the readout voltage Vr1 (first readout voltage). The decoding processing corresponds to first-time iteration of the sign shift function (first decoding processing) in FIGS. 3 and 4.

In a case where the decoder 18 fails in decoding processing, the decoder 18 further executes decoding processing by using input information ID2 (second input information) obtained by correcting the input information ID1 to be a value obtainable when being read out by the readout voltage Vr2 (second readout voltage) different from the readout voltage Vr1. The decoding processing corresponds to second-time iteration or later of the sign shift function. The decoder 18 repeatedly executes such processing until decoding processing succeeds, or until the number of times decoding processing is iterated reaches the largest value.

The decoder 18 estimates an optimum readout voltage (third readout voltage) based on reliability degree information indicating a reliability degree of decoding processing executed once or more.

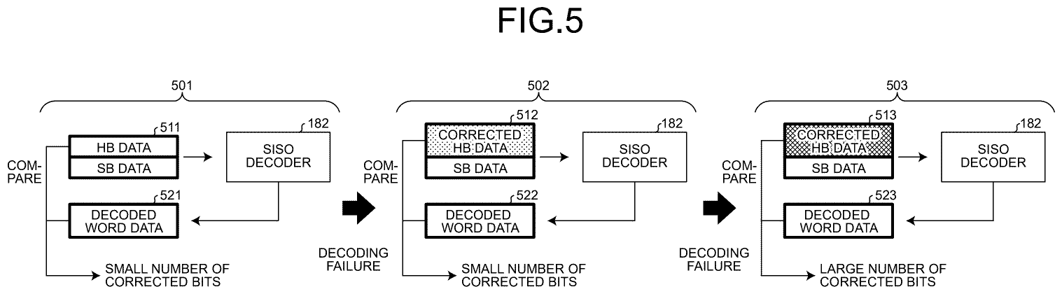

FIG. 5 is a diagram illustrating an example of estimation processing of an optimum readout voltage in a case where the number of corrected bits is used as reliability degree information. In FIG. 5, processing 501, processing 502, and processing 503 respectively corresponds to the first-time iteration, second-time iteration, and third-time iteration of the sign shift function.

In the processing 501, the SISO decoder 182 outputs decoded word data 521 indicating a decoded word obtained by the decoding processing. The SISO decoder 182 calculates the number of corrected bits based on a Hamming distance between undecoded HB data (undecoded information) and decoded HB data (decoded information), for example. For example, HB data 511 corresponds to the undecoded information and decoded word data 521 corresponds to the decoded information.

The calculation method of the number of corrected bits is not limited to this, and may be any method. For example, the decoder 18 may include a function of calculating the number of corrected bits by adding 1 during decoding processing each time bit correction is performed. In a case where identical bit is corrected twice or more, in the method of simply “adding 1 each time bit correction is performed”, the number of corrected bits to be calculated sometimes becomes larger than a correct value. Thus, in a case where a value of a bit at an identical position is corrected to an original value, 1 may be subtracted from the number of corrected bits. For example, in a case where a value of HB data of readout information of a certain bit is 0, the value is corrected to 1, and then further corrected to 0, 1 is subtracted from the number of corrected bits. The calculation accuracy of the number of corrected bits can be thereby improved.

A situation in which the number of corrected bits is small as in the processing 501 corresponds to a situation in which decoding processing does not process, that is to say, a reliability degree of decoding processing is low. If the decoding processing fails, the processing 502 corresponding to the next iteration is executed.

In the processing 502, the SISO decoder 182 executes decoding processing using readout information (corrected readout information) including corrected HB data 512 obtained by correcting the HB data 511, as input information ID2, and outputs decoded word data 522. In the processing 502, the corrected HB data 512 corresponds to undecoded information and the decoded word data 522 corresponds to decoded information.

Also in the processing 502, the number of corrected bits is small, and if decoding processing fails, the processing 503 corresponding to the next iteration is executed.

In the processing 503, the SISO decoder 182 executes decoding processing using readout information (corrected readout information) including corrected HB data 513 obtained by correcting the HB data 511, as the input information ID2, and outputs decoded word data 523. In the processing 503, the corrected HB data 513 corresponds to undecoded information and the decoded word data 523 corresponds to decoded information.

If the number of corrected bits obtained in the processing 503 (the third-time iteration) becomes the largest, the decoder 18 estimates a readout voltage based on which the corrected HB data 513 is corrected in the processing 503, to be an optimum readout voltage. For example, in a case where the processing 503 is processing of correcting readout information (HB data) to be a value read out by the readout voltage y1, similarly to the processing 303 in FIG. 3, the decoder 18 estimates an optimum readout voltage to be the readout voltage y1.

The reliability degree information is not limited to the number of corrected bits, and may be any information as long as the information indicates a reliability degree of decoding processing. For example, in a case where a multidimensional error correction code is used as an error correction code, a statistical value of a reliability degree of decoding processing corresponding to each component code may be used as a reliability degree of the entire decoding processing.

The multidimensional error correction code refers to a code in which a symbol being at least one or more constituent units of an error correction code is protected in a multiple manner by a plurality of smaller-scale component codes. A component code is a BCH code, for example.

A component code of each dimension includes one or more component coded defined for each dimension. Hereinafter, a component code corresponding to each dimension including one or more component codes will be sometimes referred to as a component code group. For example, in the case of a two-dimensional error correction code in which each symbol is protected by two component codes grouped into dimension 1 and dimension 2, a component code group of the dimension 1 and a component code group of the dimension 2 respectively include n1 component codes and n2 component codes. An applicable error correction code is not limited to this, and may be an N-dimensional error correction code in which at least one symbol of symbols included in the code is protected by N (N is an integer of 2 or more) component code groups. In a case where the code is represented by the number of component codes included in each component code group, the N-dimensional error correction code is protected by M (M is a sum of ni (1≤i≤N), N is an integer of 2 or more, ni indicates the number of i-dimensional component codes) component codes.

The decoder 18 outputs, for each component code, for example, a decoding reliability degree indicating correctness of a largest-likelihood decoded word found during decoding processing. The decoding reliability degree is represented by a probability value ranging from 0 to 1, for example. The representation method of the decoding reliability degree is not limited to this, and may be any other form. For example, the decoding reliability degree may be represented by a value quantized based on a predefined quantization bit width.

The decoder 18 calculates a statistical value of a decoding reliability degree of each component code targeted by decoding processing, as reliability degree information of the decoding processing. The statistical value is a sum or an average value, for example. The average value is a value obtained by dividing the sum of decoding reliability degrees by the number of component codes.

The reliability degree information may be the number of bits (hereinafter, Max LLR Count) of which an absolute value of processed values (hereinafter, resultant LLR) of likelihood information obtained by decoding processing becomes equal to or larger than a predefined threshold value Th (first threshold value).

Lⱼ indicating a resultant LLR of a j-th (j is an integer equal to or larger than 1 and equal to or smaller than a code length) bit is, for example, represented by the following formula (1), where xⱼ denotes a j-th bit value of a transmitted word and y denotes a received word.

$${L}_{j} = log \frac{P ( {x}_{j} = 0 \vert y )}{P ( {x}_{j} = 1 \vert y )} \qquad ( 1 )$$

The Max LLR Count is represented by the following formula (2), for example, where n denotes a code length, and I denotes an indicator function that takes 1 when a conditional expression in brackets is true and takes 0 when it is false.

$$Max LLR Count = {\sum }_{j = 1}^{n} I ( \vert {L}_{j} \vert \geq Th ) \qquad ( 2 )$$

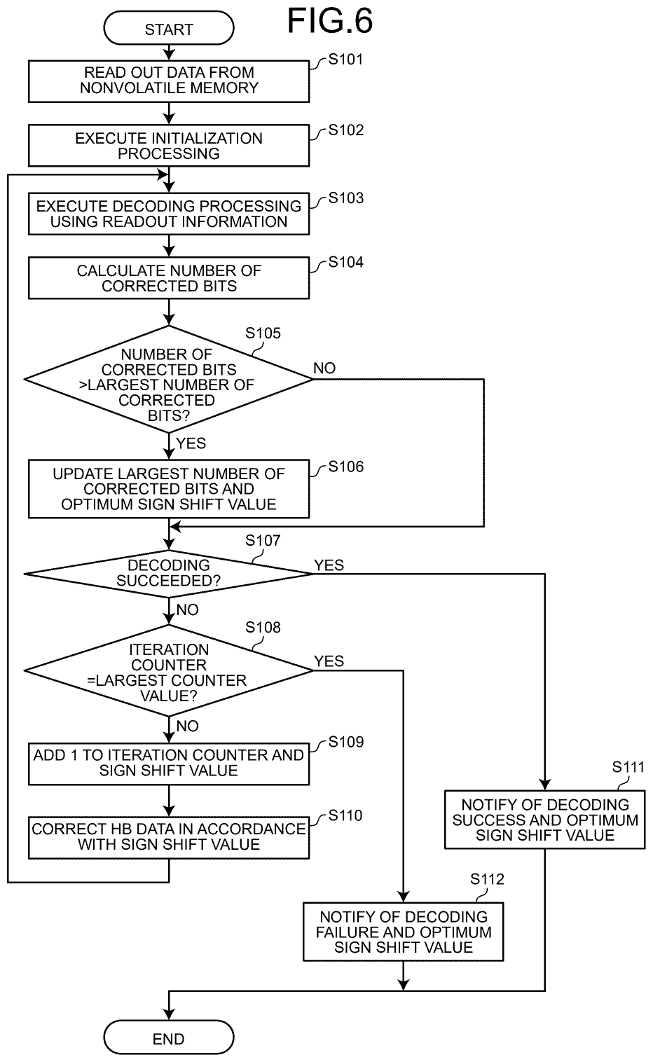

Next, a flow of decoding processing to be executed by the memory system 1 according to the first embodiment will be described. FIG. 6 is a flowchart illustrating an example of decoding processing to be executed by the memory system 1 according to the first embodiment.

The control unit 11 reads out error correction code from the nonvolatile memory 20, and obtains readout information (step S101). The control unit 11 transfers the obtained readout information to, for example, a readout information memory in the SISO decoder 182, and stores the obtained readout information thereinto. The readout information includes, for example, HB data and SB data.

The SISO decoder 182 executes initialization processing of various types of information to be used in decoding (step S102). For example, the SISO decoder 182 initializes an iteration counter, a sign shift value, the largest number of corrected bits, and an optimum sign shift value to 0. The iteration counter is a counter of the number of times iteration of the sign shift function is executed. The sign shift value is information for identifying a readout voltage to be used in each iteration of the sign shift function. The correspondence between the sign shift value and the readout voltage is predefined. The largest number of corrected bits indicates the largest value of the calculated numbers of corrected bits. The optimum sign shift value indicates sign shift value corresponding to the optimum readout voltage.

Hereinafter, as the sign shift value, a value starting from an initial value of 0 and to be incremented by 1 each time iteration is executed is used. For example, in a case where the number of times iteration is executed is three as illustrated in FIG. 3, a sign shift value is 0, 1, or 2, respectively corresponding to a value for identifying the readout voltages y2, y3, or y1. In addition, in this example, because the sign shift value and the value of the iteration counter become identical, the value of the iteration counter may be used as the sign shift value.

The SISO decoder 182 executes decoding processing following the sign shift function. In other words, the SISO decoder 182 executes decoding processing using readout information including HB data and SB data, as the input information ID1 (step S103). The first decoding processing corresponds to the first-time iteration of the sign shift function.

The SISO decoder 182 calculates the number of corrected bits in the decoding processing (step S104). The SISO decoder 182 determines whether or not the number of corrected bits is larger than the largest number of corrected bits (step S105).

In a case where the number of corrected bits is larger than the largest number of corrected bits (step S105: Yes), the SISO decoder 182 updates the largest number of corrected bits with the value of the number of corrected bits, and updates an optimum sign shift value with a current sign shift value (step S106).

After the update processing, or in a case where it is determined in step S105 that the number of corrected bits is equal to or smaller than the largest number of corrected bits (step S105: No), the SISO decoder 182 determines whether or not decoding has succeeded (step S107). The success in decoding may be discovery of a decoded word that can determined to be correct, for example.

In a case where decoding has not succeeded (step S107: No), the SISO decoder 182 determines whether or not the iteration counter has reached a largest counter value (step S108). The largest counter value is a value defined as the largest value of the number of times iteration of the sign shift function is executed.

In a case where the iteration counter has not reached the largest counter value (step S108: No), the SISO decoder 182 adds 1 to the iteration counter and the sign shift value (step S109).

The SISO decoder 182 corrects HB data in accordance with the sign shift value, and generates corrected HB data (step S110). In the example in FIG. 3, in a case where the sign shift value is 1, similarly to the processing 302, the SISO decoder 182 generates corrected HB data in which the value of HB data of the bit 311 is corrected to 1. After that, the processing returns to step S103, and decoding processing is repeated using readout information including the corrected HB data and SB data, as the input information ID2.

In a case where it is determined in step S107 that decoding has succeeded (step S107: Yes), the decoder 18 notifies an external control unit or the like of the optimum sign shift value together with the success in decoding (step S111), and ends the decoding processing.

In a case where it is determined in step S108 that the iteration counter has reached the largest counter value (step S108: Yes), the decoder 18 notifies an external control unit or the like of the optimum sign shift value together with the failure in decoding (step S112), and ends the decoding processing.

In this manner, in the present embodiment, in whichever case of the case where decoding has succeeded and the case where decoding has failed, an optimum sign shift value is output. The output optimum sign shift value can be used to identify an optimum readout voltage. Further, the optimum readout voltage can be used as a readout voltage in subsequent data readout from the nonvolatile memory 20. For this reason, it becomes possible to increase the possibility that data is correctly read out, and execute decoding more accurately. An estimation result to be output by the decoder 18 is not limited to an optimum sign shift value (optimum readout voltage), and for example, likelihood information (LLR) may be further included.

### Modified Example 1

Heretofore, an example of a case where the number of SB data is one has been described. The number of SB data may be two or more. Hereinafter, a modified example of a case where the number of SB data is two will be described. The two pieces of SB data will be referred to as SB1 data and SB2 data. A similar procedure can be applied also to a case where the number of SB data is three or more.

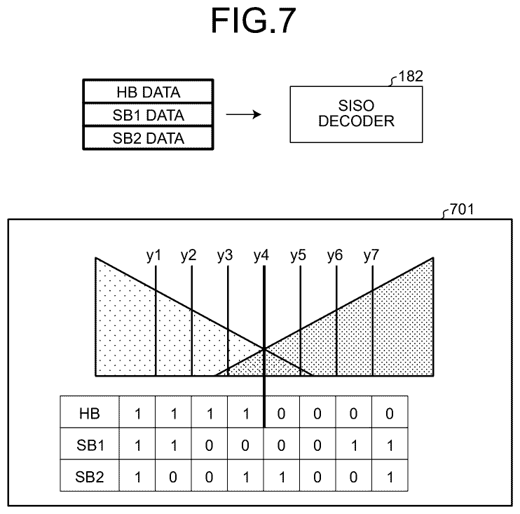

FIG. 7 is a diagram illustrating the overview of decoding processing of this modified example. In this modified example, the SISO decoder 182 executes decoding processing using readout information including one piece of HB data and two pieces of SB data including the SB1 data and the SB2 data, as the input information ID1.

As illustrated in FIG. 7, in this modified example, there are eight patterns of combinations of HB data, SB1 data, and SB2 data. Further, the number of times iteration of the sign shift function is executed is seven. The sign shift value takes a value from 0 to 6, for example, and the seven sign shift values correspond to any of seven readout voltages y1 to y7.

Processing 701 corresponds to first-time decoding processing of the sign shift function, in which readout information regarded as a value read out using the readout voltage y4 is used as-is.

In addition, SB1 data and SB2 data can be interpreted as data indicating a reliability degree (likelihood) of corresponding HB data. In the example illustrated in FIG. 7, values of (SB1 data, SB2 data) indicate lower reliability degrees in the order of (0, 1), (0, 0), (1, 0), and (1, 1). These values are example, and values with different combinations from these values may be used.

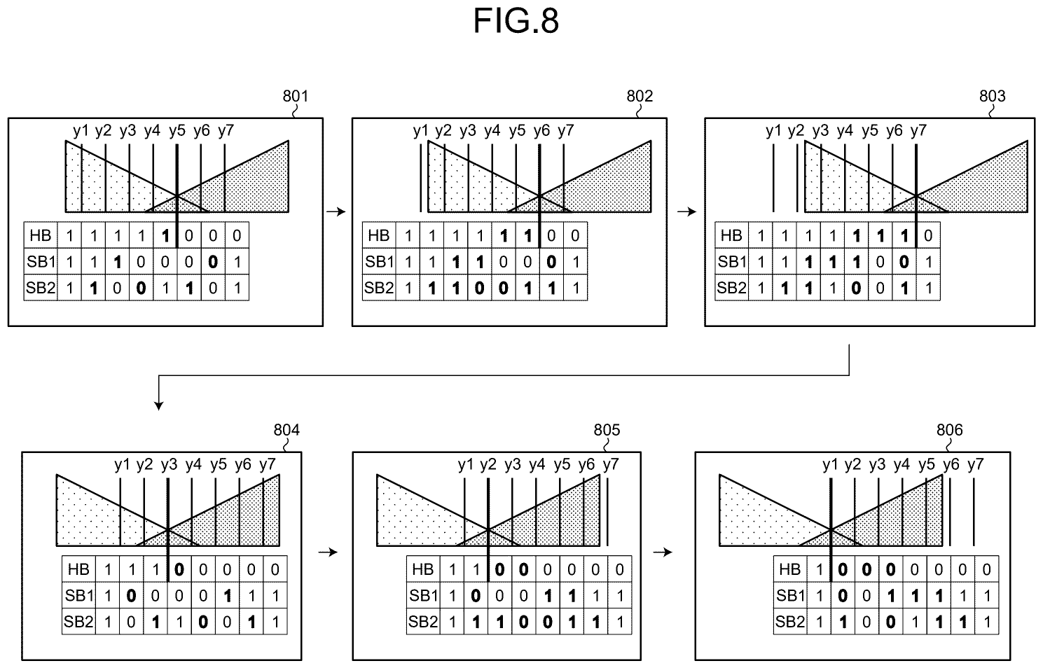

FIG. 8 is a diagram illustrating an example of iterative processing of the sign shift function in this modified example. Processing 801 to 806 correspond to second-time to seventh-time decoding processing of iterative processing of the sign shift function. In the processing 801 to 806, readout information is corrected to be values read out by readout voltages y5, y6, y7, y3, y2, and y1. Among pieces of data (HB data, SB1 data, SB2 data) in each piece of processing, bold data indicates data to be corrected.

Similarly to the above-described embodiment, HB data is corrected in such a manner that a value switches to 1 or 0 at a boundary corresponding to a switched readout voltage. The SB data (SB1 data, SB2 data) is corrected to be a value indicating a lower reliability degree as getting closer to the switched readout voltage. In addition, (SB1 data, SB2 data)=(1, 1) being SB data corresponding to the left end and the right end are not to be corrected.

The correction method of SB data is not limited to the above-described example. Further, the decoder 18 may correct only HB data without correcting SB data.

A flow of decoding processing in this modified example is similar to that in FIG. 6. While the largest counter value is 2 in the above-described embodiment in which one piece of SB data is used, the largest counter value is 6, for example, in this modified example. There is no need to use all the seven readout voltages y1 to y7. Accordingly, the largest counter value may be a value smaller than 6. For example, five readout voltages corresponding to the readout voltages y2 to y6 may be used, and 4 may be used as the largest counter value.

### Modified Example 2

Heretofore, readout information including HB data and SB data is used as input information (input information ID1, ID2). The input information to be used by the decoder 18 (the SISO decoder 182) in decoding is not limited to this. In this modified example, an example of using likelihood information obtained by converting readout information using conversion information, as input information will be described.

The likelihood information is the above-described log-likelihood ratio (LLR), for example. The conversion information is the above-described LLR table, for example.

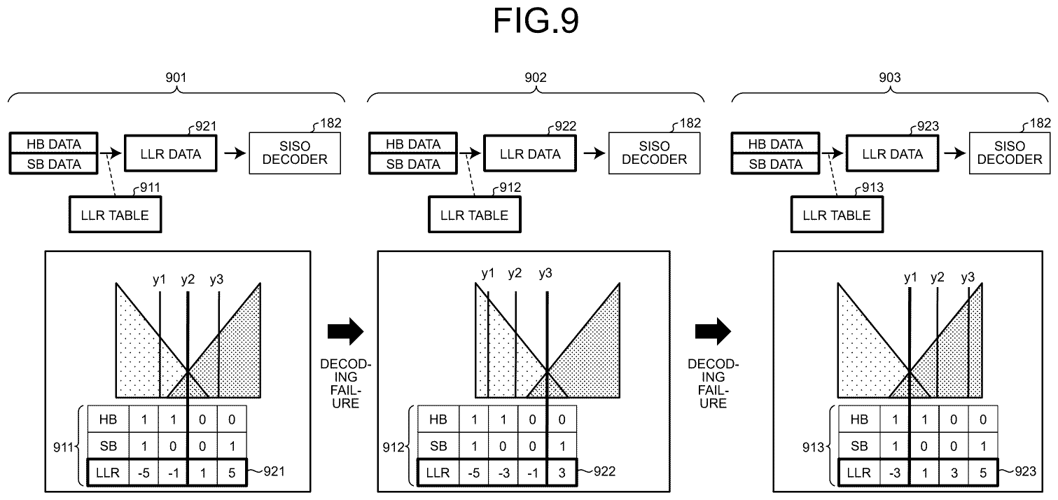

FIG. 9 is a diagram illustrating an example of iterative processing of the sign shift function in this modified example. In addition, this modified example is an example of using readout information including one piece of SB data. A similar procedure can be applied also to a case where readout information including two or more pieces of SB data is used.

Processing 901, 902, and 903 respectively correspond to first-time, second-time, and third-time iteration of the sign shift function.

In this modified example, the decoder 18 (the SISO decoder 182) executes each piece of decoding processing of the sign shift function in such a manner as to use different likelihood information (LLR) in accordance with the switching of a readout voltage, without correcting readout information (HB data, SB data).

For example, in the processing 901 being the first-time iteration of the sign shift function, the SISO decoder 182 executes decoding processing using LLR data 921 obtained by converting readout information (HB data, SB data) using an LLR table 911 (first conversion information), as the input information ID1. The LLR table 911 corresponds to an LLR table corresponding to the readout voltage y2.

In a case where the decoding processing in the processing 901 has failed, the processing 902 is executed. In the processing 902, the SISO decoder 182 executes decoding processing using LLR data 922 obtained by converting readout information using an LLR table 912 (second conversion information) different from the LLR table 911, as the input information ID2. The LLR table 912 corresponds to an LLR table corresponding to the readout voltage y3.

In a case where the decoding processing in the processing 902 has failed, the processing 903 is executed. In the processing 903, the SISO decoder 182 executes decoding processing using LLR data 923 obtained by converting readout information using an LLR table 913, as the input information ID2. The LLR table 913 corresponds to an LLR table corresponding to the readout voltage y1.

The LLR tables 911, 912, and 913 are defined to output mutually-different LLR values for readout information (HB data, SB data) with the same values. Each LLR table is defined in such a manner that the sign of the LLR (positive or negative) switches at the boundary corresponding to the switched readout voltage. The LLR tables 912 and 913 (second conversion information) can be interpreted as corresponding to LLR tables obtained by correcting the existing LLR table 911 (first conversion information) to be converted into values obtainable when being read out by the switched readout voltage.

FIG. 9 illustrates the conversion into LLR data using an LLR table is executed on the outside of the SISO decoder 182, but the conversion may be executed inside the SISO decoder 182.

In a case where the number of corrected bits is used as reliability degree information, in this modified example, the number of corrected bits may be calculated as follows. In other words, the SISO decoder 182 calculates the number of corrected bits based on a Hamming distance between a hard decision value (undecoded information) of likelihood information and a hard decision value (decoded information) of a resultant LLR, for example.

The hard decision value is a binary value defining whether 0 or 1 is indicated by each bit. For example, in a case where the value of likelihood information (LLR, resultant LLR) is positive, the hard decision value is 0, and in a case where the value of likelihood information is negative, the hard decision value is 1. In a case where the value of likelihood information is 0, a hard decision value is decided in accordance with a predefined rule (e.g. a hard decision value is set to 0)

### Modified Example 3

In the above-described description, the decoder 18 estimates an optimum readout voltage based on a readout voltage used in decoding processing executed when a reliability degree indicated by reliability degree information is the largest. For example, in a case where the number of corrected bits is used as reliability degree information, an optimum sign shift value corresponding to the largest number of corrected bits is estimated as a sign shift value corresponding to an optimum readout voltage, and output.

A method of estimating an optimum readout voltage using reliability degree information is not limited to the above-described method. For example, in a case where a difference between the largest value and the second largest value of a reliability degree of decoding processing executed a plurality of times (decoding processing iterated twice or more using the sign shift function) is equal to or larger than a threshold value (second threshold value), the decoder 18 may estimate an optimum readout voltage based on a readout voltage used in decoding processing in which the reliability degree becomes the largest. In a case where the difference is smaller than the threshold value, the decoder 18 estimates an optimum readout voltage based on a predefined readout voltage (readout voltage used in the first time, etc.), for example. Only when the difference is larger than the threshold value, the likelihood that a readout voltage obtained when a reliability degree becomes the largest is optimum is interpreted as being large, and the readout voltage can be estimated to be an optimum readout voltage.

In a case where the largest value of a reliability degree of decoding processing is equal to or larger than a threshold value (third threshold value), the decoder 18 may estimate an optimum readout voltage based on a readout voltage used in decoding processing in which a reliability degree becomes the largest. In a case where the largest value is smaller than the threshold value, the decoder 18 estimates an optimum readout voltage based on a predefined readout voltage (readout voltage used in the first time, etc.), for example. Only when the largest value of the reliability degree is larger than the threshold value, the likelihood that a readout voltage obtained when a reliability degree becomes the largest is optimum is interpreted as being large, and the readout voltage can be estimated to be an optimum readout voltage.

### Second Embodiment

In the second embodiment, another configuration example of executing decoding more accurately using an optimum readout voltage estimated by the first embodiment will be described. The second embodiment uses a concatenated code of an error correction code (ECC) ECC1 (first error correction code) of the first embodiment, and an error correction code ECC2 (second error correction code) different from the error correction code ECC1. The error correction code ECC2 is an error correction code with a constraint that an exclusive OR of a plurality of symbols included in a code word becomes 0. An error correction code with such a constraint includes, for example, a code that uses XOR parity, and an RS code. Hereinafter, an example of using a code that uses XOR parity, as the error correction code ECC2 is employed.

The XOR parity is calculated by an exclusive OR (XOR) of each bit for a plurality of ECC frames. An ECC frame is a unit of encoding and decoding by the error correction code ECC1, and corresponds to a code word encoded using the error correction code ECC1, for example.

Hereinafter, an example of calculating XOR parity for seven ECC frames (frames F0 to F6) will be described. A frame including XOR parity of each bit is used as an XOR frame for XOR parity (frame F7). Data including j-th bit of each ECC frame (frames F0 to F6) and j-th bit of the XOR frame (frame F7) corresponds to a code word encoded using the error correction code ECC2.

In the configuration of using the above-described concatenated code, for example, in a case where the decoding of an ECC frame to be decoded (hereinafter, will be referred to as a target frame) has failed, an ECC frame other than the target frame is decoded. Then, the target frame is corrected using the decoded ECC frame and the constraint of XOR, and decoding processing is executed again using the corrected target frame. The decoding success probability can be thereby improved.

In addition, the correction of the target frame that is based on the constraint of XOR is processing different from the processing correcting the input information ID1 to the input information ID2 as in the first embodiment. Hereinafter, in some cases, the processing correcting the input information ID1 to the input information ID2 as in the first embodiment will be described as correction Am_A, and correction that is based on the constraint of XOR, which is to be used in the second embodiment, will be described as correction Am_B.

On the other hand, for example, in a situation in which a deviation of a readout voltage is large, and decoding fails in an XORed ECC frame (frame other than the target frame), in some cases, an uncorrected error remains in the target frame, and decoding success probability in re-decoding declines.

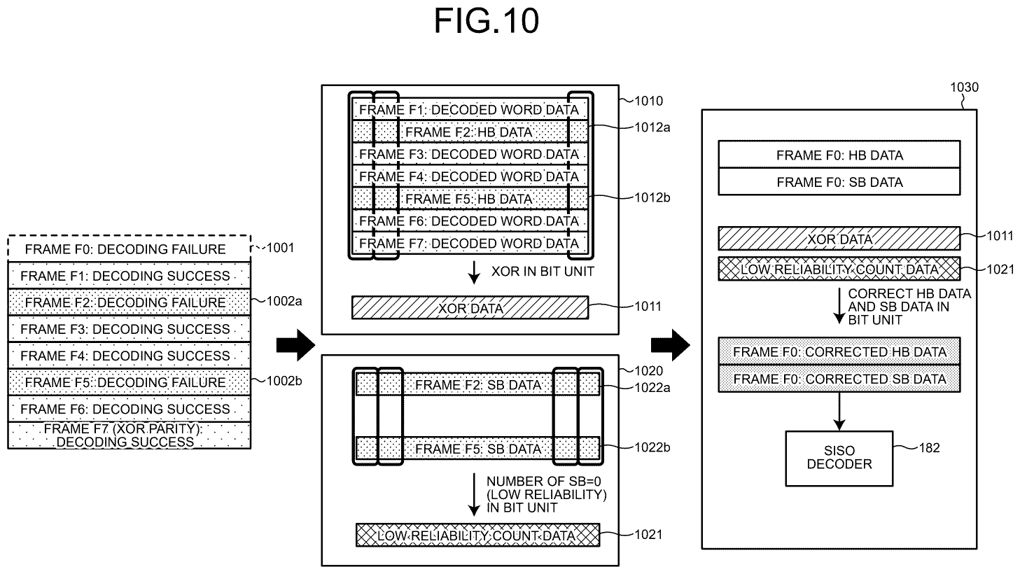

FIG. 10 is a diagram illustrating a configuration (Comparative Example) in which decoding fails. In the example illustrated in FIG. 10, a target frame is a frame F0. Further, decoding processing on readout information 1001 (target readout information) of the frame F0 is assumed to have failed.

In this case, as illustrated in the left part of FIG. 10, seven frames (frames F1 to F7) which are frames other than the target frame (frame F0), and included in a frame group XORed with the target frame are decoded. By the decoding, while readout information of the frames F1, F3, F4, F6, and F7 has succeeded in decoding, readout information 1002a and readout information 1002b of the frames F2 and F5 have failed in decoding.

Next, data necessary for the correction Am_B of the target frame is generated using the constraint of XOR. Processing 1010 and processing 1020 indicate an example of processing of generating data. In the processing 1010, XOR data 1011 is generated by calculating XOR in a bit unit. The XOR data 1011 is one of data necessary for the correction Am_B of the target frame. In the frames in which decoding has succeeded, decoded word data being a result of decoding processing is used for the calculation of XOR. On the other hand, in the frames in which decoding has failed, for example, HB data included in readout information is used for the calculation of XOR. In the example illustrated in FIG. 10, as for the frames F2 and F5 in which decoding has failed, HB data 1012a and 1012b are used for the calculation of XOR.

In the processing 1020, the number of SB data indicating a low reliability degree (for example, SB data with a value of 0) is counted in a bit unit, and low reliability count data 1021 including a count value of each bit is generated. The low reliability count data 1021 is one of data necessary for the correction Am_B of the target frame. The low reliability count data 1021 is generated using SB data of a frame in which decoding has failed. In the example illustrated in FIG. 10, SB data 1022a and 1022b of the frames F2 and F5 in which decoding has failed are used in the counting of the number of SB data indicating a low reliability degree.

Next, data of the target frame is corrected using the XOR data 1011 and the low reliability count data 1021, and decoding processing is executed again suing the corrected data. Processing 1030 indicates an example of the correction Am_B and re-decoding of the target frame. The details of the correction Am_B of the target frame will be described later. In addition, corrected HB data and corrected SB data in the processing 1030 respectively indicate data obtainable after the correction Am_B is executed on HB data and SB data of the target frame (frame F0).

In the Comparative Example illustrated in FIG. 10, HB data (HB data 1012a and 1012b) are used in the generation of the XOR data 1011, and SB data (SB data 1022a and 1022b) are used in the generation of the low reliability count data 1021. For this reason, for example, due to a large deviation in readout voltage and many errors included in HB data, the quality of generated XOR data sometimes deteriorates (error is included). In a similar manner, due to a large deviation in readout voltage and many errors included in SB data, the quality of the generated low reliability count data 1021 sometimes deteriorates (error is included). Consequently, also by the correction Am_B of the target data in the processing 1030, many errors remain and decoding fails in some cases.

In view of the foregoing, the memory system 1 of the present embodiment corrects data to be used for the generation of data necessary for the correction Am_B of the target frame (the XOR data 1011, and the low reliability count data 1021), using an optimum readout voltage estimated by the method of the first embodiment. With this configuration, even in a situation in which a deviation of a readout voltage is large, it becomes possible to reduce errors included in HB data and SB data, and improve decoding success probability.

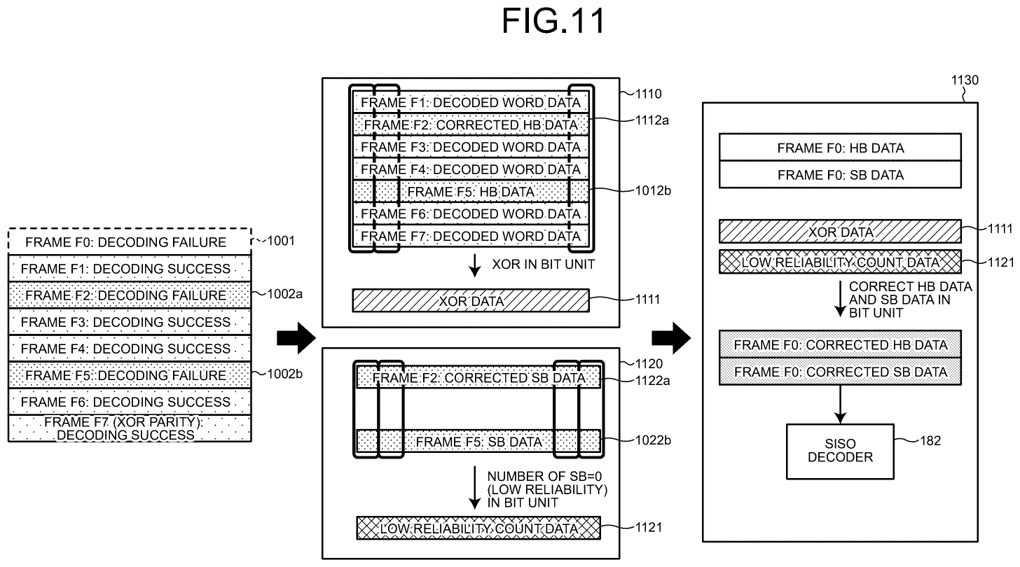

FIG. 11 is a diagram illustrating a processing example according to the present embodiment. Similarly to FIG. 10, the target frame is the frame F0. The decoder 18 (the SISO decoder 182) first executes decoding processing using readout information (target readout information) for the target frame (frame F0). The decoding processing is decoding processing using the sign shift function that is similar to the processing in the first embodiment. As illustrated in FIG. 11, decoding processing on the frame F0 is assumed to have failed.

In this case, readout information (hereinafter, untargeted readout information) for a plurality of ECC frames other than the target frame (frame F0) is read out from a nonvolatile memory. The SISO decoder 182 executes decoding processing on a plurality of pieces of untargeted readout information using the sign shift function. In the example illustrated in FIG. 11, decoding processing is executed using untargeted readout information for each ECC frame (frames F1 to F7). Accordingly, an optimum readout voltage for each ECC frame is estimated.

Next, data necessary for the correction Am_B of the target frame is generated using the constraint of XOR. Processing 1110 and processing 1120 in FIG. 11 indicates an example of processing of generating data.

In the present embodiment, the SISO decoder 182 executes correction processing (correction Am_A) of generating one or more pieces of input information ID2 obtained by correcting one or more pieces of input information ID1 corresponding to one or more pieces of untargeted readout information failed in decoding processing, among a plurality of pieces of untargeted readout information, to have values obtainable when being read out by an estimated optimum readout voltage.

In the processing 1110 in FIG. 11, the SISO decoder 182 corrects HB data 1012a to corrected HB data 1112a corresponding to data corrected to have values obtainable when being read out by an optimum readout voltage. In addition, for example, in a case where a readout voltage corresponding to the first-time iteration of the sign shift function is estimated to be an optimum readout voltage, HB data may be used as-is for the calculation of XOR without being corrected. HB data 1012b in FIG. 11 is an example of HB data not to be corrected.

Further, in the processing 1120 in FIG. 11, the SISO decoder 182 corrects SB data 1022a to corrected SB data 1122a corresponding to data corrected to have values obtainable when being read out by an optimum readout voltage. Similarly to HB data, SB data may be used as-is for the generation of low reliability count data without being corrected. SB data 1022b in FIG. 11 is an example of SB data not to be corrected.

The SISO decoder 182 generates XOR data 1111 using a plurality of pieces of input information ID2 obtained after correction processing (correction Am_A) is executed. Further, the SISO decoder 182 generates the low reliability count data 1121 using a plurality of pieces of input information ID2 obtained after correction processing (correction Am_A) is executed.

Next, the SISO decoder 182 executes the correction Am_B of the input information ID1 of the target frame using the XOR data 1111 and the low reliability count data 1121. The SISO decoder 182 executes decoding processing again using the corrected input information ID1. The processing 1130 indicates an example of the correction Am_B and re-decoding of the target frame.

In this manner, using an optimum readout voltage estimated by the method of the first embodiment, the SISO decoder 182 of the present embodiment executes the correction Am_A of readout information (HB data, SB data) of an ECC frame failed in decoding, among a plurality of ECC frames to be used in the correction Am_B that is based on the constraint of the XOR. Then, the SISO decoder 182 executes the correction Am_B that is based on the constraint of the XOR, using the corrected readout information. With this configuration, the influence of the deviation of the readout voltage is mitigated, and the accuracy of data to be used in the correction Am_B that is based on the constraint of the XOR can be improved. Consequently, it is possible to improve the success probability of re-decoding that uses data corrected by the correction Am_B that is based on the constraint.

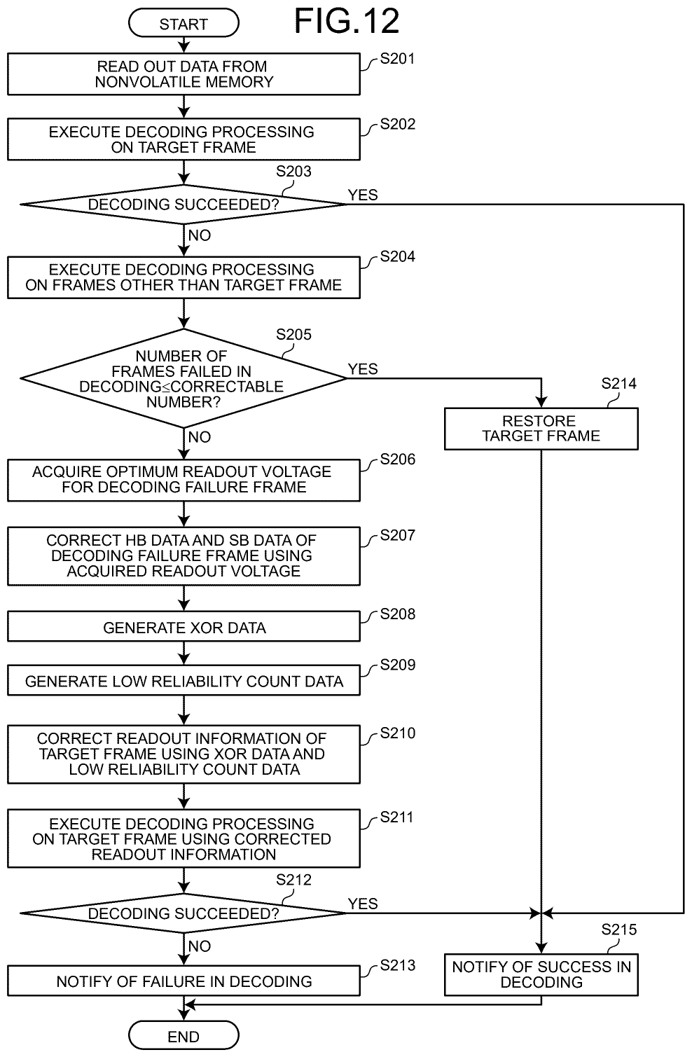

Next, a flow of decoding processing to be executed by the memory system 1 according to the second embodiment will be described. FIG. 12 is a flowchart illustrating an example of decoding processing to be executed by the memory system 1 according to the second embodiment.

The control unit 11 reads out an error correction code corresponding to s target frame, from the nonvolatile memory 20, and obtains readout information of the target frame (target readout information) (step S201). The control unit 11 transfers the target readout information to a readout information memory in the SISO decoder 182, for example, and stores the target readout information thereinto.

The SISO decoder 182 executes decoding processing on the target frame (step S202). For example, the SISO decoder 182 executes decoding processing by the sign shift function using the target readout information.

The SISO decoder 182 determines whether or not decoding has succeeded (step S203). In a case where decoding has not succeeded (step S203: No), the SISO decoder 182 executes decoding processing on frames other than the target frame (step S204). For example, the SISO decoder 182 executes the decoding processing by the sign shift function using a plurality of pieces of untargeted readout information read out for a plurality of ECC frames other than the target frame.

The SISO decoder 182 determines whether or not the number of frames failed in decoding, among a plurality of ECC frames included a frame group to be XORed, is equal to or smaller than a correctable number (step S205). The correctable number is the number of frames that can be corrected using the error correction code ECC2. In a case where XOR is used, the correctable number is 1, for example.

In a case where the number of frames failed in decoding is larger than the correctable number (step S205: No), the SISO decoder 182 acquires an optimum readout voltage for an ECC frame failed in decoding (hereinafter, decoding failure frame) (step S206). For example, the SISO decoder 182 acquires an optimum readout voltage estimated in the decoding processing by the sign shift function in step S204. In a case where the correction Am_A that uses an optimum readout voltage is to be executed also on the target frame, the SISO decoder 182 may acquire an optimum readout voltage estimated in the decoding processing by the sign shift function in step S202.

The SISO decoder 182 executes correction processing (correction Am_A) of correcting HB data and SB data of the decoding failure frame using the acquired readout voltage (step S207).

The SISO decoder 182 generates XOR data using decoded word data or HB data (including corrected HB data) of each frame that is obtained after correction processing (step S208). Further, the SISO decoder 182 generates low reliability count data using SB data (including corrected SB data) of the decoding failure frame that is obtained after correction processing (step S209).

The SISO decoder 182 executes the correction Am_B of readout information of the target frame using the XOR data and the low reliability count data (step S210). The SISO decoder 182 executes decoding processing on the target frame again using corrected readout information (step S211).

The SISO decoder 182 determines whether or not decoding has succeeded (step S212). In a case where decoding has not succeeded (step S212: No), the SISO decoder 182 notifies an external control unit or the like of a failure in decoding (step S213), and ends the decoding processing.

In a case where it is determined in step S205 that the number of frames failed in decoding is equal to or smaller than the correctable number (step S205: Yes), the SISO decoder 182 restores the target frame using the error correction code ECC2 (step S214).

After step S214, in a case where it is determined in step S212 that decoding has succeeded (step S212: Yes), and in a case where it is determined in step S203 that decoding has succeeded (step S203: Yes), the SISO decoder 182 notifies an external control unit or the like of a decoded word together with a success in decoding (step S215), and ends the decoding processing.

Next, the details of the correction Am_B of the target frame, which is illustrated in the processing 1030 in FIG. 10, the processing 1130 in FIG. 11, and steps S210 and S211 in FIG. 12, will be described.

First of all, input data and output data of the correction Am_B of the target frame are described below.

### Input Data

Input HB data: HB data of the target frame (corrected HB data obtained after the correction Am_A is executed in accordance with an optimum readout voltage)
Input SB data: SB data of the target frame (corrected SB data obtained after the correction Am_A is executed in accordance with an optimum readout voltage)
XOR data: data obtained by obtaining exclusive OR (XOR) of a hard decision value for each bit for all ECC frames other than the target frame. As the hard decision value, decoded word data is used in an ECC frame succeeded in decoding, and corrected HB data obtained after the execution of correction Am_A is used in an ECC frame failed in decoding.
Low reliability count data: data obtained by counting the number of bits with a low reliability degree (low reliability bits) for each bit for all decoding failure ECC frames other than the target frame.
The number of decoding failure ECC frames: the number of ECC frames failed in decoding (including the target frame)

### Output Data

Corrected HB data: HB data obtained by executing the correction Am_B on input HB data of the target frame
Corrected SB data: SB data obtained by executing the correction Am_B on input SB data of the target frame

The overview of the procedure of the correction Am_B of the target frame will be described below.
(S01) Using input HB data and input SB data, LLR data L⁽¹⁾ is calculated.
(S02) Using low reliability count data and the number of decoding failure ECC frames, extrinsic LLR data is calculated.
(S03) Using XOR data, LLR data L⁽¹⁾, and extrinsic LLR data, LLR data L⁽²⁾ is calculated.
(S04) Using the LLR data L⁽²⁾, corrected HB data and corrected SB data are calculated.

For example, in accordance with the above-described procedure, the SISO decoder 182 calculates output data (corrected HB data, correction SB data) from input data. The SISO decoder 182 may calculate output data using conversion information (conversion table, etc.) in which a value of output data calculated by the above-described procedure is preliminarily associated with a combination of input data.

The details of each of the above-described procedures will be further described. In S01, the SISO decoder 182 calculates LLR data L⁽¹⁾ in accordance with the following formula (3) for each bit of an ECC frame. Hereinafter, the j-th bit is sometimes described as a bit j. Lⱼ⁽¹⁾ denotes a value of LLR data L⁽¹⁾ of the bit j.

$${L}_{j}^{( 1 )} = \{ \begin{matrix}{( - 1 )}^{{HB}_{j}} R & WHEN {SB}_{j} = 1 ( HIGH RELIABILITY ) \\ {( - 1 )}^{{HB}_{j}} U & WHEN {SB}_{j} = 0 ( LOW RELIABILITY )\end{matrix} \qquad ( 3 )$$

Herein, HBⱼ: bit value of bit j of input HB data, SBⱼ: bit value of bit j of input SB data, R: high reliability LLR absolute value, and U: low reliability LLR absolute value.

The high reliability LLR absolute value R and the low reliability LLR absolute value U are predefined nonnegative fixed values, and satisfy R>U (for example, R=5, L=1). Formula (3) corresponds to a formula deciding the positivity or negativity of an LLR based on the value of HB data, and an absolute value of LLR based on the value of SB data. For example, a value indicating a higher reliability as an absolute value of LLR becomes larger is calculated.

In S02, the SISO decoder 182 calculates a value of extrinsic LLR data L^{(e)} in accordance with the following formula (4) for each bit of an ECC frame. Lⱼ^{(e)} denotes a value of extrinsic LLR data L^{(e)} of the bit j.

$${L}_{j}^{( e )} = 2 {tanh}^{- 1} ( {tanh}^{d - 1 - {c}_{j}} ( {R}^{′} / 2 ) {tanh}^{{c}_{j}} ( {U}^{′} / 2 ) ) \qquad ( 4 )$$

Herein, Cⱼ: value of bit j of low reliability count data, d: the number of decoding failure ECC frames, R′: high reliability LLR absolute value, and U′: low reliability LLR absolute value.

The high reliability LLR absolute value R′ and the low reliability LLR absolute value U′ are predefined nonnegative fixed values, and satisfy R′>U′. The high reliability LLR absolute value R′ and the low reliability LLR absolute value U′ may have the same values as the high reliability LLR absolute value R and the low reliability LLR absolute value U in formula (3), or may be different values. Formula (4) corresponds to a calculation formula of an extrinsic LLR under the constraint of XOR.

In the bit j, cⱼ corresponds to the number of low reliability bits, and d-1-cⱼ corresponds to the number of high reliability bits. When an extrinsic LLR for the target frame is calculated, contribution of the target frame needs to be excluded. Further, in the frame succeeded in decoding, because it can be regarded as LLR absolute value L>>1, because tanh (L) corresponding to contribution ≈1, the contribution does not appear in the representation. For this reason, the sum of the number of low reliability bits cⱼ, and the number of high reliability bits d-1-c; becomes d-1.

In S03, the SISO decoder 182 calculates a value of the LLR data L⁽²⁾ in accordance with the following formula (5) for each bit of the ECC frame. Lⱼ⁽²⁾ denotes a value of the LLR data L⁽²⁾ of the bit j.

$${L}_{j}^{( 2 )} = {L}_{j}^{( 1 )} + {( - 1 )}^{{XOR}_{j}} * {L}_{j}^{( e )} \qquad ( 5 )$$

Herein, XORⱼ: bit value of bit j of XOR data, and Lⱼ^{(e)}: value of bit j of extrinsic LLR data.

Formula (5) corresponds to processing of adding an extrinsic LLR given a sign calculated from XOR data, to the value of LLR data L⁽¹⁾.

In S04, the SISO decoder 182 calculates values of corrected HB data and corrected SB data in accordance with the following formula (6) for each bit of the ECC frame. HBⱼ′ denotes a value of the corrected HB data of the bit j. SBⱼ′ denotes a value of the corrected SB data of the bit j.

$${HB}_{j}^{′} = \{ \begin{matrix}0 & WHEN {L}_{j}^{( 2 )} \geq 0 \\ 1 & WHEN {L}_{j}^{( 2 )} < 0\end{matrix} \qquad ( 6 )$$

$${SB}_{j}^{′} = \{ \begin{matrix}1 & WHEN \vert {L}_{j}^{( 2 )} \vert > T ( HIGH RELIABILITY ) \\ 0 & WHEN \vert {L}_{j}^{( 2 )} \vert \leq T ( LOW RELIABILITY )\end{matrix}$$

Herein, Lⱼ⁽²⁾: value of bit j of LLR data Lⱼ⁽²⁾, and T: reliability degree threshold value. Predefined nonnegative fixed value (for example, T=1).

A value of HBⱼ′ when Lⱼ⁽²⁾=0 may be decided by a method other than the formula (6). For example, under the design where Lⱼ⁽¹⁾ does not take 0, the value of HBⱼ′ may be decided in accordance with the sign of Lⱼ⁽¹⁾ (when Lⱼ⁽¹⁾ is positive, HB′=0, when Lⱼ⁽¹⁾ is negative, HB′=1, etc.).

As described above, in the second embodiment, in an error correcting technique that uses an error correction code (XOR parity, etc.) with a constraint that an exclusive OR of a symbol becomes 0, by using data corrected using an estimated optimum readout voltage, it becomes possible to execute error correcting more accurately.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile memory configured to store an error correction code;
a memory controller configured to:
read out readout information from the nonvolatile memory by using a first readout voltage;
execute decoding processing by using first input information, the first input information being one of the readout information and likelihood information obtained by converting the readout information by first conversion information;
when the decoding processing has failed, further execute the decoding processing by using second input information obtained by correcting the first input information to be a value obtainable when being read out by a second readout voltage different from the first readout voltage; and
estimate a third readout voltage based on reliability degree information indicating a reliability degree of the decoding processing.

2. The memory system according to claim 1, wherein the second input information includes one of corrected readout information obtained by correcting the readout information to be the value obtainable when being read out by the second readout voltage, and the likelihood information obtained by converting the readout information by second conversion information obtained by correcting the first conversion information to be converted into the value obtainable when being read out by the second readout voltage.

3. The memory system according to claim 1, wherein the reliability degree information includes the number of corrected bits indicating the number of bits corrected in the decoding processing.

4. The memory system according to claim 3, wherein the second input information includes one of corrected readout information obtained by correcting the readout information to be the value obtainable when being read out by the second readout voltage, and the likelihood information obtained by converting the readout information by second conversion information obtained by correcting the first conversion information to be converted into the value obtainable when being read out by the second readout voltage, and the number of corrected bits is a Hamming distance between: undecoded information that is one of the readout information, the corrected readout information, and a hard decision value of the likelihood information; and decoded information that is one of a decoded word obtained by the decoding processing and a hard decision value of a processed value of likelihood information obtained by the decoding processing.

5. The memory system according to claim 3, wherein the memory controller is configured to calculate the number of corrected bits by adding 1 each time bit correction is performed in the decoding processing, and by subtracting 1 each time a value of a bit is corrected to return to an original value.

6. The memory system according to claim 1, wherein the error correction code includes an N-dimensional error correction code in which at least one symbol of symbols included in a code is protected by N (N is an integer of 2 or more) component code groups, and the reliability degree information includes a statistical value of a reliability degree of the decoding processing for M (1 ≤ i ≤ N, ni indicates the number of component codes included in an i-dimensional component code group, M is a sum of ni) component codes.

7. The memory system according to claim 1, wherein the reliability degree information indicates the number of bits of which an absolute value of a processed value of likelihood information obtained by the decoding processing becomes equal to or larger than a first threshold value.

8. The memory system according to claim 1, wherein the memory controller is configured to estimate the third readout voltage based on a readout voltage used in the decoding processing executed when the reliability degree indicated by the reliability degree information has become largest.

9. The memory system according to claim 8, wherein when a difference between a largest value and a second largest value of the reliability degree of the decoding processing executed a plurality of times is equal to or larger than a second threshold value the memory controller is configured to estimate the third readout voltage based on a readout voltage used in the decoding processing executed when the reliability degree has become largest.

10. The memory system according to claim 8, wherein when a largest value of the reliability degree of the decoding processing is equal to or larger than a third threshold value, the memory controller is configured to estimate the third readout voltage based on a readout voltage used in the decoding processing executed when the reliability degree has become largest.

11. The memory system according to claim 1, wherein the readout information includes, for each bit, hard bit data indicating a hard decision value, and one or more soft bit data indicating a reliability degree of the hard decision value.

12. The memory system according to claim 11, wherein the first input information includes the readout information, the second input information includes corrected readout information obtained by correcting the readout information to be the value obtainable when being read out by the second readout voltage, and when the decoding processing has failed, the memory controller is configured to obtain the corrected readout information for each bit included in the readout information, by inverting a value of the hard bit data corresponding to the soft bit data indicating a low reliability degree.

13. The memory system according to claim 1, wherein the error correction code includes a concatenated code of a first error correction code and a second error correction code, the second error correction code has a constraint that an exclusive OR of a plurality of symbols included in a code word becomes 0, and the memory controller is configured to:
read out, from the nonvolatile memory, target readout information that is the readout information of the first error correction code to be decoded;
when the decoding processing using the target readout information has failed, read out, from the nonvolatile memory, a plurality of piece of untargeted readout information that is the readout information for a plurality of the first error correction codes other than a decoding target;
execute correction processing of generating one or more pieces of the second input information obtained by correcting one or more pieces of the first input information corresponding to one or more pieces of the untargeted readout information failed in the decoding processing, among the plurality of pieces of the untargeted readout information, to be a value obtainable when being read out by the estimated third readout voltage;
calculate an exclusive OR by using one or more piece of the second input information on which the correction processing has been executed;
correct the first input information corresponding to the target readout information by using the calculated exclusive OR; and
execute decoding processing by using the corrected first input information.

14. The memory system according to claim 13, wherein the memory controller is configured to:
calculate an exclusive OR of decoded word data corresponding to one or more piece of the untargeted readout information succeeded in the decoding processing, and one or more piece of the second input information on which the correction processing corresponding to one or more piece of the untargeted readout information failed in the decoding processing has been executed; and
correct the first input information corresponding to the target readout information by using the calculated exclusive OR.

15. The memory system according to claim 13, wherein the memory controller is configured to:
calculate the number of symbols with a reliability degree lower than other symbols, among a plurality of symbols included in the second error correction code, by using one or more pieces of the second input information on which the correction processing has been executes; and
correct the first input information corresponding to the target readout information by using the calculated exclusive OR and the calculated number.

16. A memory controller being configured to:
read out readout information by using a first readout voltage from a nonvolatile memory storing an error correction code;
execute decoding processing by using first input information, the first input information being one of the readout information and likelihood information obtained by converting the readout information by first conversion information;
when the decoding processing has failed, further execute the decoding processing by using second input information obtained by correcting the first input information to be a value obtainable when being read out by a second readout voltage different from the first readout voltage; and
estimate a third readout voltage based on reliability degree information indicating a reliability degree of the decoding processing.

17. A method of controlling a nonvolatile memory, the method comprising:
reading out readout information by using a first readout voltage from a nonvolatile memory storing an error correction code;
executing decoding processing by using first input information, the first input information being one of the readout information and likelihood information obtained by converting the readout information by first conversion information;
when the decoding processing has failed, further executing the decoding processing by using second input information obtained by correcting the first input information to be a value obtainable when being read out by a second readout voltage different from the first readout voltage; and
estimating a third readout voltage based on reliability degree information indicating a reliability degree of the decoding processing.
